(19) United States
(12) Patent Application Publication
(10) Pub. No.: US 2005/0119953 A1
(43) Pub. Date: Jun. 2, 2005

(54) Intelligent system infrastructure for financial data computation, report remittance and funds transfer over an interactive communications network

(76) Inventors: Hong M. Dang, Los Gatos, CA (US); Hwei-Hwa Alice Lin, Cupertino, CA (US); Martin Trostel, Tuebingen (DE); Kooi Karl Yap, Cupertino, CA (US)

Correspondence Address: HEWLETT-PACKARD COMPANY;Intellectual Property Administration, P.O. Box 272400, Fort Collins, CO, 80527-2400, US

(21) Appl. No.: 10/941,458

(22) Filed: Sep. 14, 2004

Related U.S. Application Data
(62) Division of application No. 09/995,492, filed on Nov. 26, 2001.

(51) Int. Cl. G06F 17/60

(52) U.S. Cl. 705/31

(57) ABSTRACT

This disclosure relates to a specific, illustrative multilayer architecture for a program controlled system for providing services relating to financial data computation, report remittance and funds transfer services over an interactive communications network. The system comprises a subscriber server for hosting a virtual portal having at least one application for providing e-content to end users, the application including a network browser for accessing, displaying and transmitting data over the network. A first service provider server allows a system administrator to access the system remotely. A first security system for protecting the system from entry of unwanted data during data transfer over the network between the subscriber and service provider servers and the interactive communications network level. Also provided are plurality of primary servers including a primary network server, a primary tax computation server, a primary report generation server and a primary tax remittance server. The network server receives a tax computation transaction request from the subscriber server, transmits the request to the primary tax computation server, and returns data processed by the tax computation server to the subscriber server. In addition, the system has a plurality of secondary servers redundant to the first. The secondary servers include a secondary network server, a secondary tax computation server, a secondary report generation server and a secondary tax remittance server. A load balancing and scalability system is utilized for load directing, routing and switching functions during data transfer from utilization of at least one function at one of the primary servers to a corresponding function at a secondary server for optimum management of system resources.

### BACKGROUND OF THE INVENTION

The present invention relates generally to data processing and, more particularly, to a novel system infrastructure for financial data computation and revenue remittance over an interactive communication network.

Domestic businesses are usually required by state and local authorities to charge sales and/or use tax for most commercial transactions relating to goods. Typically, each business is required to (i) calculate based upon a formula how much to charge for each transaction, (ii) file a return with the authorities identifying the amount of revenue collected, sales and use tax accrued and any exemptions, (iii) periodically remit the amount of taxes owed to the authorities, (iv) issue check requests, and (iv) defend audits undertaken by such authorities.

Traditional methods of preparing and reporting tax information to government authorities have involved significant manual effort. In particular, at the close of each reporting period (monthly, quarterly or annually), financial representatives of the merchants, e.g., accountants, would consolidate all of the merchant's relevant sales and other transactional data and manually calculate the amount of sales tax owed. Selected forms, periodic tax payments, checks and other paperwork often necessary for reporting taxes would then be sent to the authorities via “snail mail”. Since this process is essentially manual and is usually based only on information provided by the merchant, the merchant often had control over what was disclosed to their representative and, ultimately, what was reported to the authorities. Consequently, this practice allowed those relatively unscrupulous merchants to avoid paying taxes on considerable portions of their sales and other commercial transactions.

As a manual process, this method has also been prone to human error, not only in the accuracy of data collected, but also in the computation of the taxes owed. In addition, tax remittance was frequently delayed due to documents being late or lost in the mail, or merchants simply forgetting or otherwise omitting to remit sales and other transactional data to the authorities. The merchant would then be penalized for the late or incorrect tax payment.

In this connection, with the advent of the computer, many businesses developed customized tax calculation systems in order to semi-automate the tax preparation process. While these systems have been useful, because businesses and their financial constructs vary widely, the software used often needed to be tailored not only to each trade, but also specific applications had to be created to meet the particular requirements of each business. This resulted in considerable expense as well as delay in servicing the business's software needs. To further automate the tax preparation process, it was often necessary to integrate the tax software solutions with other business software. This required further customization of software applications as well as that of interface and other programs needed for integrating system-wide applications. Moreover, these systems frequently required trained personnel for effective operation and proper system maintenance. Despite the automation, an accounting staff was still required to monitor and review the accuracy of each tax calculation, and to prepare tax returns. This was especially true where the taxable transactions involved multiple tax jurisdictions, since traditional systems lacked the analytical capability for multi-jurisdictional tax decisions.

Still other systems required dedicated hardware and communications links. Although effective for some operations, these systems similarly required modification for application to new businesses, in other countries, or for purposes of monitoring transactions other than those for which it was designed. With the onset of e-commerce, although attempts have been made to adapt existing systems to the on-line environment, tax authorities have found themselves unable to monitor or collect sales tax on transactions that are conducted over the Internet.

Moreover, these systems have experienced difficulty in maintaining high-level security, namely, privacy, authentication and integrity during system access and transaction processing, especially during complex transactions or other tasks where large volumes of financial data are exchanged over the Internet. As the volume and complexity of transactions increases, the system must be able to instantaneously compensate. When so burdened, conventional systems often struggle with operability, reliability, availability, scalability and load balancing, whereas the consumer, e.g., the financial industry, demands their on-line availability twenty-four (24) hours a day, seven (7) days a week. To insure long term supportability, such systems must also utilize free public domain, commonly off-the-shelf (or CTOS), open source and other industry standard software.

Accordingly, a system infrastructure is desired that enables a Web service to conduct tax transactions securely over the Internet, requires minimal staff to operate, relatively low cost to setup, provides continuous availability while being readily scalable and having load balancing capabilities, and utilize open source software and other industry standard software for long-term supportability.

### SUMMARY OF THE INVENTION

According to one aspect of the present invention is an intelligent, program controlled system for providing services relating to financial data computation, report remittance and finds transfer services over an interactive communications network. The system has programming which includes a first security service for protecting the system from entry of unwanted data during data transfer over the network. A second security service is also provided for controlling user access to at least one of the system services. Also utilized is a subscriber availability service for monitoring the availability of subscriber servers. A notification service transmits a message to a system administrator when a selected condition has been met. Monitoring of the usage of the operating system is provided by an operating system service, and monitoring of the availability of internal support processes is effected by a system availability service. A system backup and recovery service periodically performs backup of system data so as to maintain a plurality of duplicate data sets on each system server for auditing and database recovery. In addition, a secure access service allows a system administrator to access the system remotely. This service has programming for encrypting all data transferred so as to eliminate eavesdropping, connection hijacking and network-level virus attacks. Further, a system utility service is used for tracking login/logout, object creation, deletion, editing and rule base changes. System load balancing and scalability service provides for management of system resources. It also provides balancing of the data load between servers, detection and activation of standby systems, i.e., those for handing increased system data volume. Finally, this service effects switching of the data load from one server to the other upon server failure.

In accordance with another aspect of the present invention is a multilayer architecture for a program controlled system for providing services relating to financial data computation, report remittance and funds transfer services over an interactive communications network. The system comprises a subscriber layer, an interactive communications network layer, an applications layer, a database layer and a financial link layer. The subscriber layer includes a subscriber server for hosting a virtual portal having at least one application for providing e-content to end users. The application is preferably provided with a network browser for accessing, displaying and transmitting data over the network. A first service provider server allows a system administrator to access the system remotely. Also provided is a first security system for protecting the system from entry of unwanted data during data transfer over the network between the subscriber and service provider servers and the interactive communications network level. In addition, a load balancing and scalability system enables load directing, routing and switching functions during data transfer. The interactive communications network layer has a server with programming for receiving a tax computation transaction request from the subscriber server, transmitting the request to the applications layer, and returning data processed by the applications layer to the subscriber server. Next, the applications layer includes at least one server having first programming for providing application transaction services. These services relate to financial data computation and report remittance over the network. Second programming of the applications layer provide infrastructure services including system management and administration. Furthermore, the database layer has a plurality of redundant database servers for storing a tax computation transaction request initiated from the subscriber server and a response of data processed by the applications layer. As for the financial link layer, it has redundant programming for effecting electronic transfer of funds to a selected financial institution over the network. Finally, the system is provided with a second security system for protecting the system from entry of unwanted data during data transfer over the network between the financial link layer and the financial institution.

According to a further aspect of the present invention, there is provided a multilayer architecture for a program controlled system for providing services relating to financial computation, report remittance and funds transfer services over an interactive communications network. The system comprises a subscriber layer, an interactive communications network layer, an applications layer, a database layer and a financial link layer. The subscriber layer includes a subscriber server having at one application for providing e-content to end users. The application preferably includes a network browser for accessing, displaying and transmitting data over the network. A first service provider server allows a system administrator to access the system remotely. In addition, a first security system is provided which protects the system from entry of unwanted data during data transfer over the network between the subscriber and service provider servers and the interactive communications network level. System load directing, routing and switching functions during data transfer are provided by a system load balancing and scalability system. Next, the interactive communications network layer includes a plurality of network servers. Each server has redundant programming for receiving a tax computation transaction request from the subscriber server, transmitting the request to the applications layer, and returning data processed by the applications layer to the subscriber server. Likewise, the applications layer has a plurality of application servers. Each server is provided with redundant application transaction services programming for financial data computation and report remittance over the network, and redundant infrastructure services programming for system management and administration. In addition, the database layer is provided with a plurality of redundant database servers for storing a tax computation transaction request initiated from the subscriber server and a response of data processed by the applications layer. As for the financial link layer, it has redundant programming for effecting electronic transfer of funds to a selected financial institution over the network. A second security system protects the system from entry of unwanted data over the network between the financial link layer and the financial institution.

In accordance with still another aspect of the present invention is a multilayer architecture for a program controlled system for providing financial data computation, report remittance and funds transfer services over an interactive communications network. The system comprises a subscriber server for hosting a virtual portal with at least one application for providing e-content to end users. The application preferably includes a network browser for accessing, displaying and transmitting data over the network. A first service provider server is provided for allowing a system administrator to access the system remotely. A first security system protects the system from entry of unwanted data during data transfer over the network between the subscriber and service provider servers and the interactive communications network level. Next, a plurality of primary servers are utilized, including a primary network server, a primary tax computation server, a primary report generation server and a primary tax remittance server. The network server receives a tax computation transaction request from the subscriber server, transmits the request to the primary tax computation server, and returns data processed by the tax computation server to the subscriber server. In addition, a plurality of secondary servers are provided that are redundant to the first. They include a secondary network server, a secondary tax computation server, a secondary report generation server and a secondary tax remittance server. The network server receives a tax computation transaction request from the subscriber server, transmits the request to the secondary tax computation server, and returns data processed by the tax computation server to the subscriber server. Finally, a load balancing and scalability system facilitates load directing, routing and switching functions, during data transfer, from utilization of at least one function at one of the primary servers to a corresponding function at a secondary server for optimum management of system resources.

According to a yet a further aspect of the present invention is a multilayer architecture for a program controlled system for providing financial data computation, report remittance and funds transfer services over an interactive communications network. This comprises a subscriber server for hosting a virtual portal having at least one application for providing e-content to end users. Desirably, the application has a network browser for accessing, displaying and transmitting data over the network. A first service provider server allows a system administrator to access the system remotely. A first security system is provided for protecting the system from entry of unwanted data during data transfer over the network between the subscriber and service provider servers and the interactive communications network level. Also provided is a plurality of primary servers, including a primary network server, a primary tax computation server, a primary report generation server and a primary tax remittance server. The network server receives a tax computation transaction request from the subscriber server, transmits the request to the primary tax computation server, and returns data processed by the tax computation server to the subscriber server. Next, a plurality of secondary servers are utilized that are redundant to the first. They include a secondary network server, a secondary tax computation server, a secondary report generation server and a secondary tax remittance server. The network server receives a tax computation transaction request from the subscriber server, transmits the request to the secondary tax computation server, and returns data processed by the tax computation server to the subscriber server. Finally, a load balancing and scalability system provides load directing, routing and switching functions, during data transfer, from utilization of at least one function at one of the primary servers to a corresponding function at a secondary server for optimum management of system resources. At least one of the servers has redundant network services programming for financial data computation and report remittance over the network, and redundant infrastructure services programming for system management and administration.

In accordance with still a further aspect of the present invention is a method for automatically computing sales and/or use tax on a selected transaction, reporting the taxes owed, and transmitting funds corresponding to the taxes owed to a selected government authority over an interactive communications network. Initially, a sales and/or use tax calculation transaction request is sent from a network browser of a subscriber server, over the network, to a firewall device of a program controlled system for providing financial data computation, report remittance and funds transfer. Approval is then obtained for passing the request through the device and sending the approved request to a primary network server. Next, the request is transmitted from the primary network server to a primary tax computation server, and the taxes owed are computed on the computation server. The taxes computed are stored in a database server under a selected subscriber account, and a response is sent with the amount of taxes computed to the subscriber server. Thereafter, the taxes computed are transmitted to a reporting server upon receiving a report transaction request from the subscriber server and/or government authority. The data processed by the tax computation server is reported to the subscriber and/or government authority. Finally, funds corresponding to the taxes computed are remitted to a server of a selected financial institution for transmission to the government authority.

According to another aspect of the present invention, a method is provided for automatically computing taxes owed on a selected transaction, reporting the taxes owed, and transmitting funds corresponding to the taxes owed to a selected government authority over an interactive communications network. First, a sales transaction request is sent from a network browser of a subscriber server, over the network, to a firewall device of a program controlled system for providing financial data computation, report remittance and funds transfer. Approval is then obtained for passage of the request through the device and sending the approved request to a primary network server. Next, the request is transmitted from the primary network server to a primary tax computation server, whereupon failure of the primary network server, a load balancing and scalability system redirects the data transfer from the primary network server to a corresponding secondary network server. The secondary server has programming that is redundant to that of the primary network server. The taxes owed are then computed on the computation server. Upon failure of the primary tax computation server, a load balancing and scalability system redirects the data transfer from the primary tax computation server to a corresponding secondary tax computation server. The secondary tax computation server has programming that is redundant to that of the primary tax computation server. The taxes computed are stored in a database server under a selected subscriber account. Thereafter, a response is sent with the amount of taxes computed to the subscriber server, whereupon failure of the primary tax computation server, a load balancing and scalability system redirects the data transfer from the primary tax computation server to a corresponding secondary tax computation server. The secondary tax computation server is equipped with programming that is redundant to that of the primary tax computation server. Next, the taxes computed are transmitted to a primary reporting server. Upon failure of the primary reporting server, a load balancing and scalability system redirects the data transfer from the primary reporting server to a corresponding secondary reporting server. The secondary reporting server has programming that is redundant to that of the primary reporting server. The data processed by the tax computation server is reported to the subscriber server and/or the government authority. In addition, the taxes computed from the primary reporting server are transmitted to the primary remittance server, whereupon failure of the primary remittance server, a load balancing and scalability system redirects the data transfer from the primary remittance server to a corresponding secondary remittance server. Programming redundant to that of the primary remittance server is provided on the secondary remittance server. Finally, funds corresponding to the taxes computed are remitted to a server of a selected financial institution for transmission to a selected government authority.

It is, therefore, an object of the present invention to provide an intelligent, automated system and method for facilitating computation of taxes owed on sales transactions and remitting the same over an interactive communications network.

Another object of the present invention is to provide an infrastructure for a automated, interactive sales tax reporting and payment system for merchants or the like.

A further object of the present invention is to provide a system and method for remitting tax data over an interactive communications network so as to eliminate the need for filing a tax return.

Still another object of the present invention is to provide a novel modular software system and infrastructure for servicing the tax preparation and submission needs of merchants or the like.

Still a further object of the present invention is to provide seamless, error free, automated tax computation and preparation services across multiple tax jurisdictions.

Yet a further object of the present invention is to provide an apparatus, a system and a method for optimizing the speed of data transfer from an XML-based transaction performed by a sales tax computation system to a TXP compatible file for an automated clearinghouse network.

Another object of the present invention is to provide a reliable, automated system and method for rapid transfer of XML-based transaction data from a sales tax computation system to TXP compatible data of an automated clearinghouse network and to transfer funds based on the transaction data to a selected government authority simply, efficiently and economically.

Still another object of the present invention is to improve the speed and quality of data transfer between merchants, financial institutions and government authorities.

A further object of the present invention is to enhance data transfer over an interactive communications network.

Yet a further object of the present invention is to provide a system infrastructure that enables merchants to electronically outsource the burden of sales tax calculation and sales tax remittance to state-certified service providers.

Still another object of the present invention is to significantly reduce the internal information technology expenses of merchants by eliminating the need to maintain an in-house, internally-developed sales tax system.

Another object of the present invention is to significantly reduce the audit exposure of participating merchants by giving government authorities access to complete transaction records electronically maintained by a tax service provider.

A further object of the present invention is to make use of off-the-shelf (COTS) technologies, Internet software industry standards, such as XML, Java, HTTPS, SOAP, Secure Shell (SSH) and/or the like, rather than proprietary, subscriber-specific software, thereby reducing considerably tax system development and deployment costs for merchants or the like.

Yet a further object of the present invention is to provide an intelligent, automated system and method for facilitating computation of taxes owed on sales transactions and remission of the same over an interactive communications network, with minimal human intervention.

Another object of the present invention is to provide a continuously available, highly secure, automated system and method, at the user level, network level and systems level, for facilitating computation of taxes owed on sales transactions and remission of the same over an interactive communications network.

Still another object of the present invention is to provide a simple, economical, versatile system and method for facilitating computation of taxes owed on sales transactions and remission of the same over an interactive communications network, having automated management functions for minimal manual support.

A further object of the present invention is to provide a system infrastructure for facilitating computation of taxes owed on sales transactions and remission of the same over an interactive communications network, that utilizes open source and other industry standard software for long-term supportability.

Yet another object of the present invention is to provide redundant network applications and operating system operations which facilitate providing financial services seamlessly over an interactive communications network.

The present invention will now be further described by reference to the following drawings which are not intended to limit the accompanying claims.

### BRIEF DESCRIPTION OF THE DRAWINGS

FIG. 1 is a flow diagram showing a multilayer architecture for a program controlled system for providing financial data computation, report remittance and funds transfer services over an interactive communications network, according to one aspect of the present invention;

FIG. 2 is a flow diagram showing a multilayer architecture for a program controlled system for providing financial data computation, report remittance and funds transfer services over an interactive communications network, in accordance with another aspect of the present invention;

FIG. 3 is a flow diagram showing a multilayer architecture for a program controlled system for providing financial data computation, report remittance and funds transfer services over an interactive communications network, according to a further aspect of the present invention;

FIG. 4 is a schematic diagram showing physical components of the system of FIG. 1;

FIG. 5 is a schematic diagram showing the services architecture of the system of FIG. 1;

FIG. 6 is a schematic diagram illustrating physical components of the system of FIG. 1, according to another aspect of the present invention

FIG. 7 is a flow diagram illustrating a process for establishing a secure communication, in accordance with the system of FIG. 1;

FIG. 8 is a schematic diagram showing a system for calculating taxes due on transactions, reporting the same to a selected government authority, and periodically remitting the taxes owed over an interactive communications, according to one aspect of the present invention;

FIG. 9 is a schematic diagram showing a system for calculating taxes due on transactions, reporting the same to a selected government authority, and periodically remitting the taxes owed over an interactive communications, according to another aspect of the present invention; and

FIG. 10 is a flow diagram showing an automated clearinghouse network, according to one aspect of the present invention.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

The present invention relates generally to an infrastructure 1 for an intelligent, program controlled apparatus 10, a system 100, a service 200 and a method 400 for identifying taxable financial transactions 11, collecting data 12 based on the transactions, calculating any tax due 13 on the transactions, reporting the same to a selected government authority 30, and periodically remitting funds 14 corresponding to the taxes owed to the government authority over an interactive communications network 20, e.g., the Internet, an intranet, an extranet, or the like. In particular, the present invention provides infrastructure 1 suitable for a state-certified, automated sales tax calculation and payment system and/or service that utilizes relatively low cost, free public domain, commonly off-the-shelf (or CTOS) web technologies, open source and other Internet industry standard software, including XML, Java, HTTPS, SOAP, Secure Shell (SSH) and/or the like, such that tax computation, tax collection, payment and filing of a tax return is done automatically for any merchant using the system or subscribing to such a service. According to one aspect of the present invention, in return for real-time or otherwise timely tax related submission to the government authority for use of the system, the merchant is desirably offered a discount on his/her taxes.

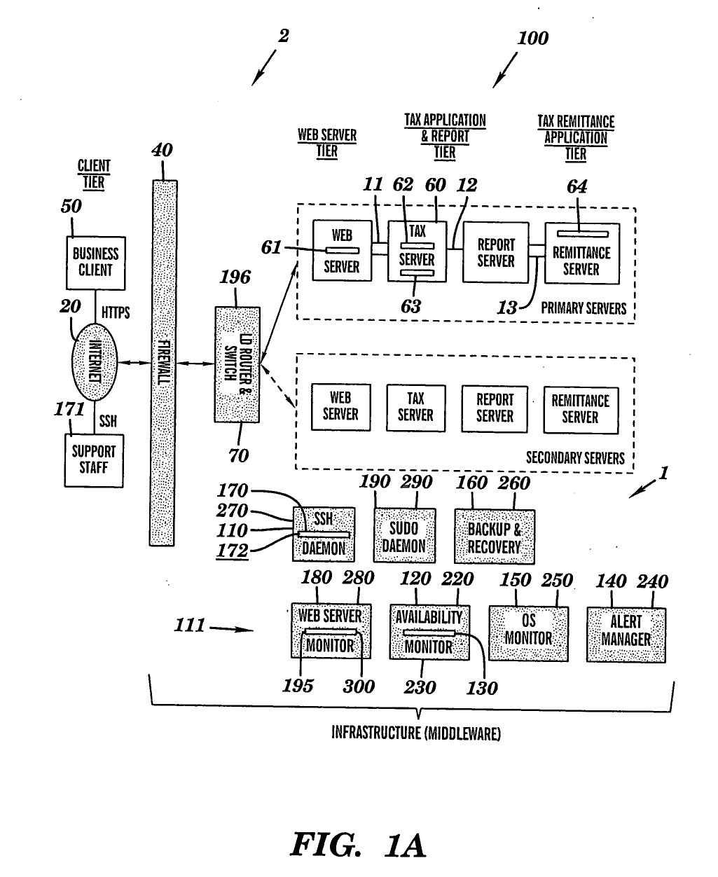

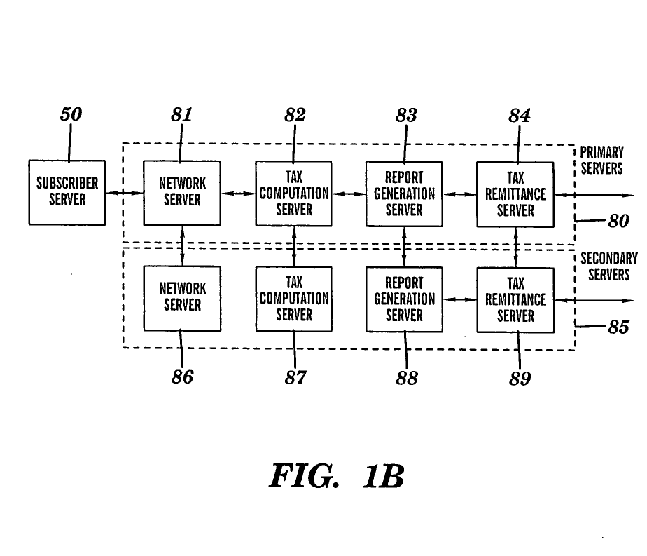

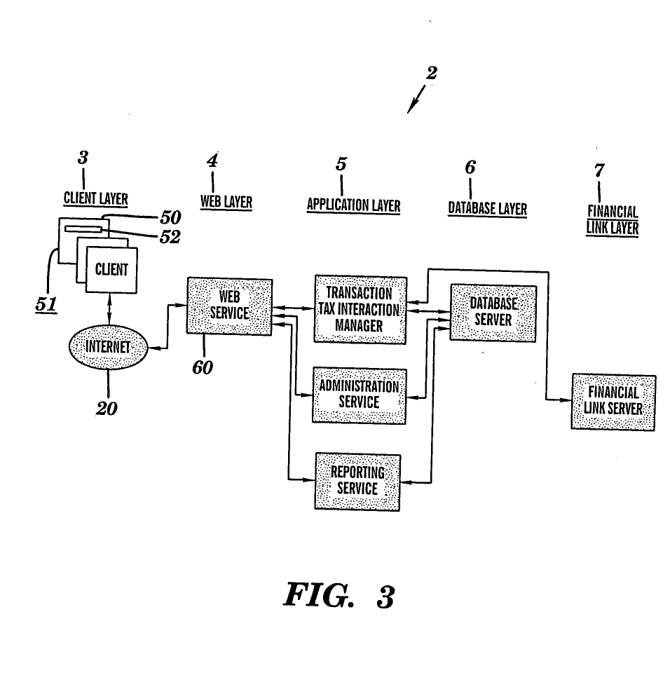

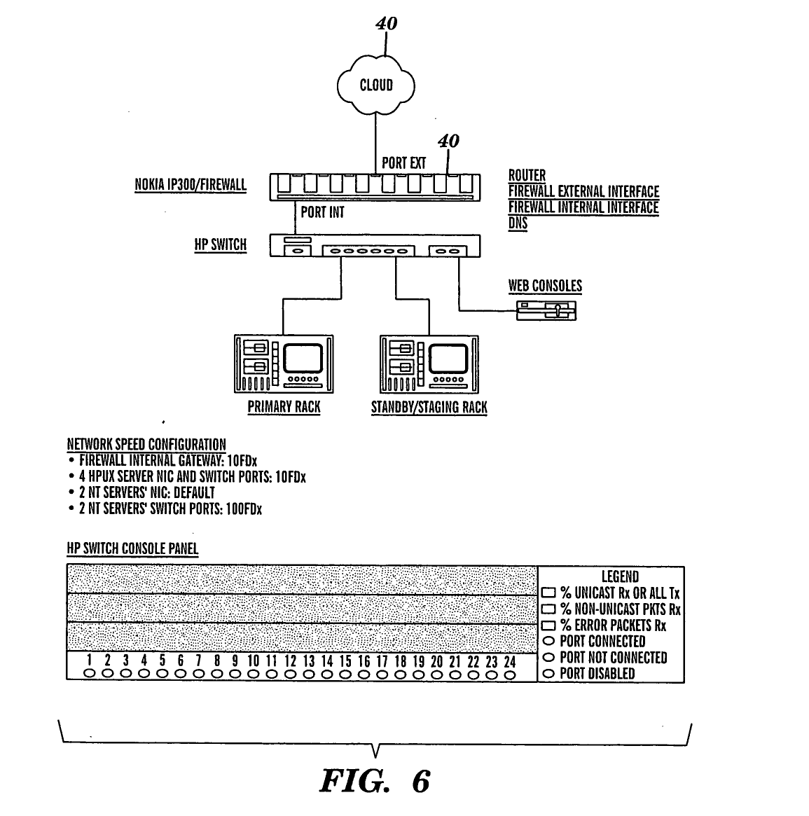

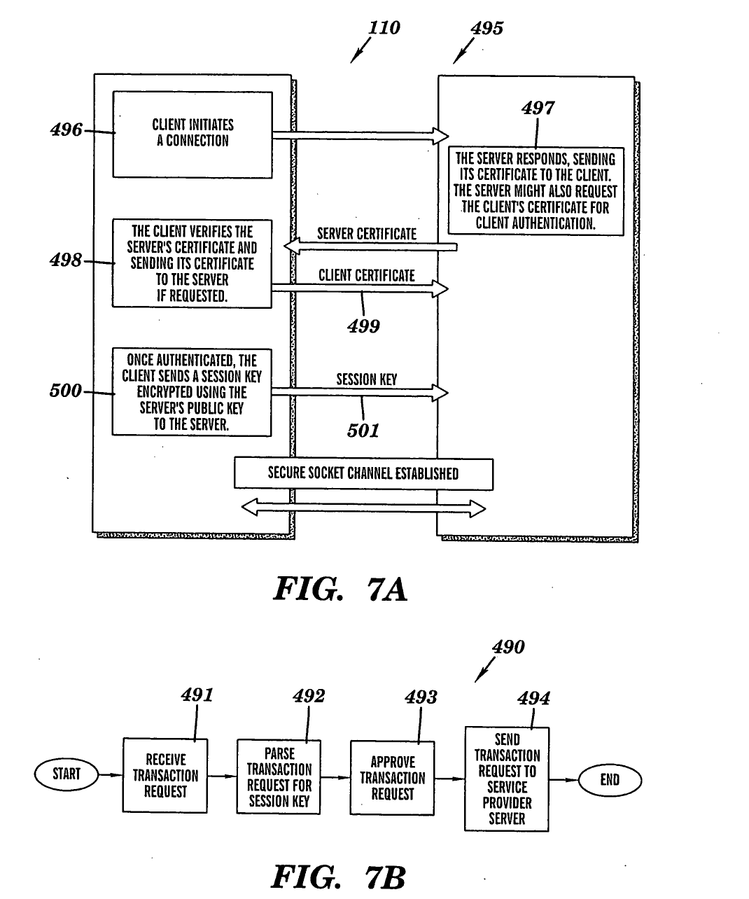

Referring now to the drawings and, more particularly, to FIGS. 1-10, there is shown a specific, illustrative, infrastructure for intelligent, program controlled system 100 for providing operations relating to financial data computation, report remittance and funds transfer services over an interactive communications network. According to one aspect of the present invention, a unique combination of programming operations are provided. First, as best seen in FIG. 1, a first security module or function 110 (See also FIG. 7) is provided for protecting the system from entry of unwanted data during data transfer over the network. In one embodiment, as shown in FIG. 6, a managed firewall device 40, e.g., Nokia IP330, provides this function.

Next, a series of monitoring modules or functions are provided for system management. First, a subscriber availability module or function 120 is provided for monitoring the availability of subscriber servers 50. A system availability module or function 130 monitors the availability of internal support processes. Another monitoring operation is a notification module or function 140 that transmits a message to a system administrator when a selected condition has been met, such as a user alert or other emergency requiring user notification. Usage of the operating system is monitored by an operating system module or function 150.

Utility operations are provided, which comprise a system backup and recovery module or function 160. This function periodically performs backup of system data for auditing and database recovery. Another operation is a secure access module or function 170 that permits a system administrator to access the system from a remote setting. The service has programming 171 for encrypting all data transferred so as to eliminate security breaches, such as eavesdropping, connection hijacking and network-level virus attacks. In addition, a system utility service or function 180 is utilized to track login/logout, object creation, deletion, editing and rule base changes. A second security service or function 190 controls access by each user, i.e., requiring user authorization and authentication, to at least one of the system services.

In addition, a system load balancing and scalability module or function 195 is utilized. This service, e.g., supplied by a device such as an HP BlueStone Load Balancer/Switch, provides a variety of functions, including management of system resources, maintaining a plurality of duplicate data sets on each system server, balancing the data load between servers, detecting and activating standby systems for handing increased system data volume, and switching the data load from one server to the other upon server failure.

At the kernel of the present invention is a novel multilayer architecture 2 for the program controlled system. Generally speaking, as illustrated in FIGS. 1-3, the system comprises a merchant or subscriber layer 3, an interactive communications network or Web-based layer 4, an applications layer 5, a database layer 6 and a financial link layer 7. In one embodiment, the subscriber layer includes at least one subscriber server 50 for hosting a virtual portal 51 having at least one application 52 for providing e-content to end users. Preferably, a conventional network browser 53, e.g., Microsoft Internet Explorer 4.0 or higher, is utilized for accessing, displaying and transmitting data over the network.

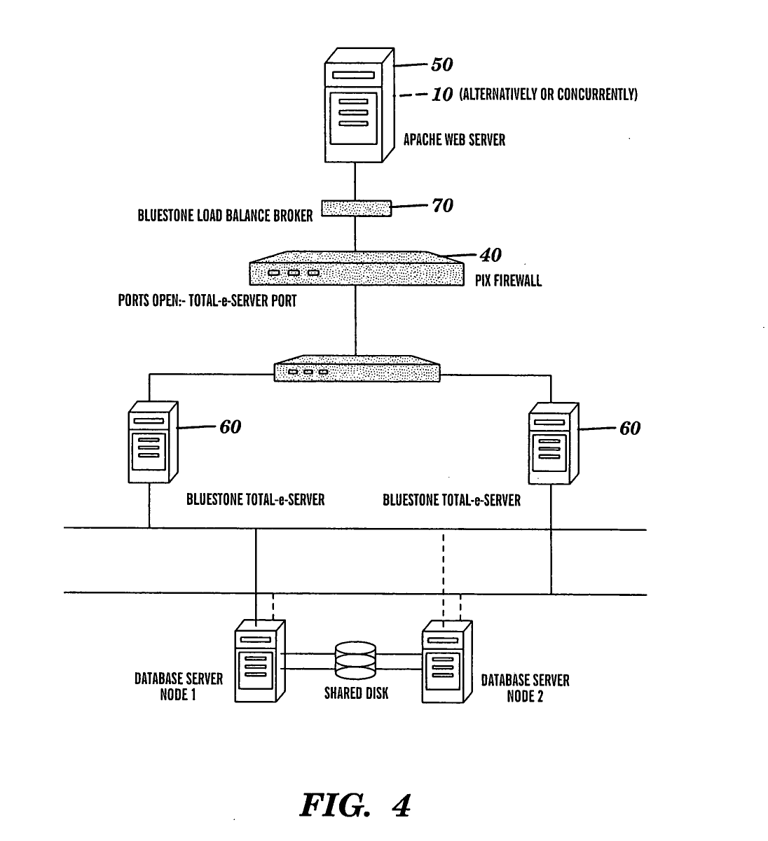

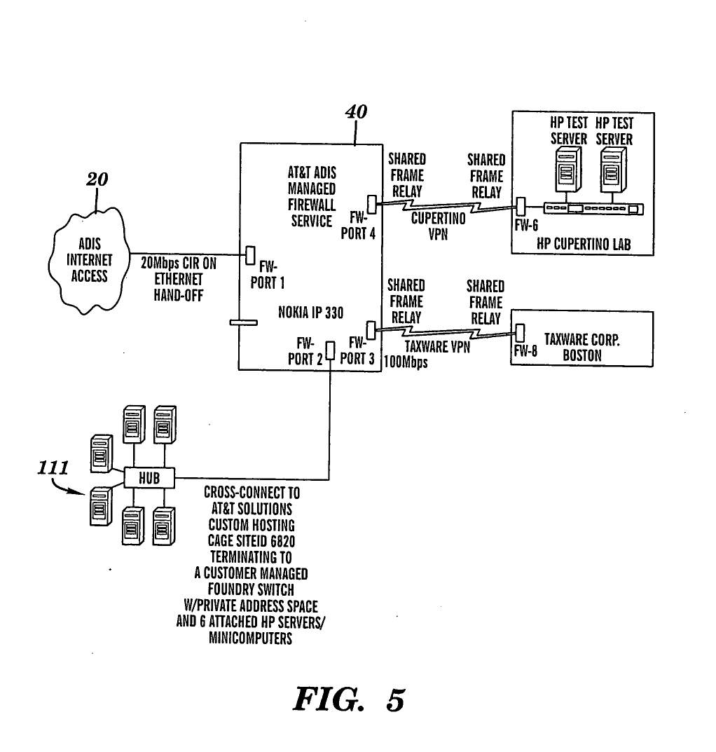

Next, the data enters interactive communications network layer 4. Whether desiring entry to the applications layer from the subscriber server or from a first service provider server 60, managed firewall device 40 is encountered. This device protects the system from entry of unwanted data during data transfer from the subscriber level, through the network level (which includes servers and communications infrastructure of a conventional Internet service provider), to the next level or applications layer 5. Enroute to the applications layer, according to one embodiment, load balancing and scalability system 70, at the network level, detects the current data load or volume entering the system and, if appropriate, redirects the destination of data transfer for optimum system operation and management. In one embodiment, as best seen FIG. 4, network layer 4 also includes first service provider server 60, e.g., HP Apache Web server, having programming 61 for parsing HTTPS messages entering the system.

Upon arrival at the applications layer, a second service provider module or function 62, e.g., an XML transdorm module or the like, on first service provider server 60 interprets XML-based transaction requests or messages entering the system and invokes Web-based services at the applications level. More particularly, server programming 61 also provides for receiving a tax computation transaction request from subscriber server 50, transmitting the request to the tax computation module, and returning the data processed by function 62 to the subscriber server. It also hosts the financial data or tax computation programming 63 and that 64 for report remittance over the interactive communications network.

In addition, the first service provider server hosts a series of the monitoring functions provided for system management. For instance, it host subscriber availability service 220 for monitoring availability of the subscriber servers. It also hosts a system availability service 230 which monitors the availability of internal support processes, a notification service 240 for transmitting messages to the system administrator, and operating system service 250 for monitoring usage of the operating system.

This server further hosts the utility functions, including system backup and recovery service 260. Another function housed on the server is secure access service 270 that permits a system administrator to access the system from a remote setting. In addition, system utility service 280 is provided for tracking login/logout, object creation, deletion, editing and rule base changes. Further hosted on the server is a second security service 290 for controlling access by each user, i.e., requiring user authorization and authentication, to at least one of the system services.

Finally, the first service provider server houses system load balancing and scalability service 300, including management of system resources, maintaining a plurality of duplicate data sets on each system server, balancing the data load between servers, detecting and activating standby systems for handing increased system data volume, and switching the data load from one server to the other upon server failure.

Although the present invention is shown and described in the context of sending and receiving data in XML-based and TXP-based formats, it will be appreciated by those skilled in the art that other suitable data formats may be utilized, within the spirit and scope of the present invention. In addition, while the present invention is illustrated as having first service provider server for hosting numerous system monitoring and other utility functions, it is understood that a plurality of service provider servers may be provided, each hosting one or more applications and/or any combination thereof on the multiple servers, giving consideration to the purpose for which the present invention is intended.

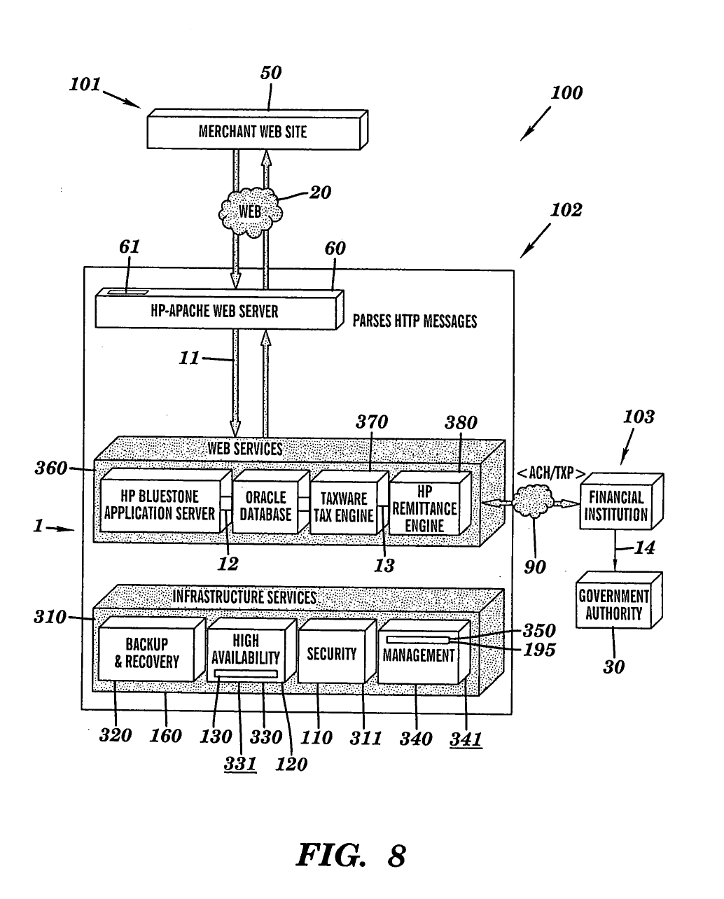

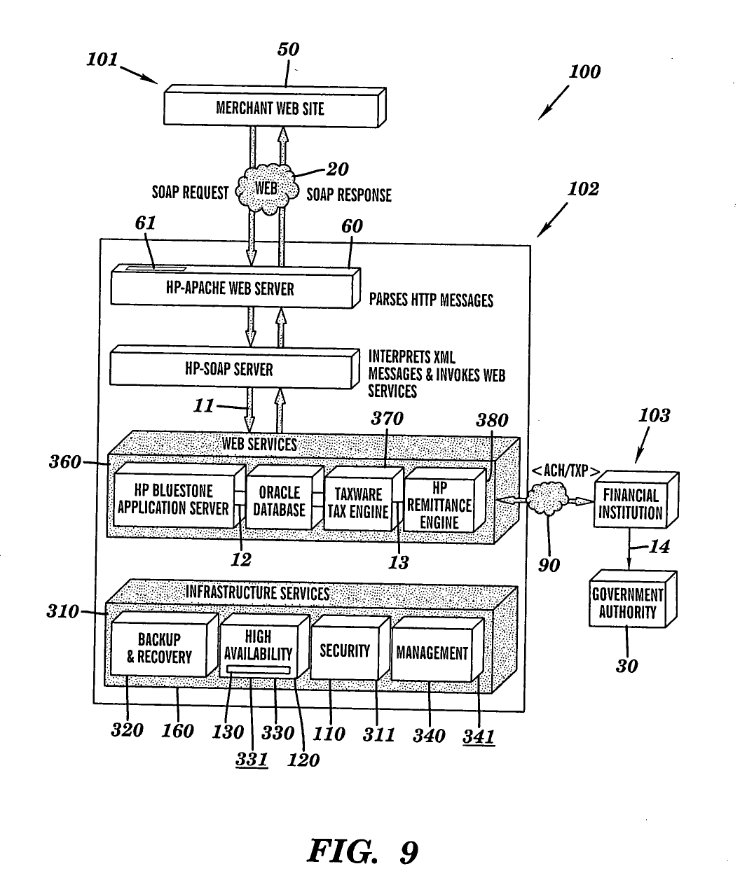

Generally speaking, it is preferred that the infrastructure components of the present invention be in modular form. In one embodiment, as shown in FIGS. 8 and 9, an infrastructure module 310 is provided as a service module for performing a series of discrete operations, each of which is preferably also in modular form. Module 310 operatively houses a security module 320 which insures system security over the interactive communications network. Functions of the security module include, but are not limited to, encryption, access control, subscriber/server authentication and/or the like. A second module 320 is recovery and backup function 160, e.g., Oracle 8i export and import services. A third module 330 is a real-time, continuous operation, and accessibility function 331 for insuring to both subscribers and government authorities that the on-line service is available relatively continuously, e.g., seven days a week, twenty-four hours a day. A fourth module 340, or system monitoring function 341, allows the system of the present invention to be remotely managed by technical staff. Finally, a fifth module 350 provides load balancing and scalability function 195. This enables the system to scale-up for handling transactions for a relatively large number of subscribers and to distribute system workloads, accordingly.

To take advantage of this service, a merchant, for instance, subscribes to the service provider and obtains code necessary for interfacing with operations of the service provider. Preferably, the merchant-subscriber's computer system is Web-compatible, i.e., suitable for establishing Web-based communications with the service system provider by conventional means.

In addition, according to one aspect of the present invention, the service provider system has a plurality of software or functional modules 360 operating in a Web environment. Each time the subscriber makes a transaction, the subscriber's computer system contacts the service provider system by sending a transaction request using Web protocols (e.g., HTTPS Post). In one embodiment, a transaction request is an XML-based message containing or identifying a selected class of goods (e.g., clothes), the value of a selected item of the goods, the subscriber location, the subscriber's taxpayer identification number (and/or subscriber's account number with the service), the time of the message, the date and the shipping location. The transaction is preferably encrypted with a service provider system's public key. It is desirable that only a service provider system having the corresponding private key may decrypt the message and, in turn, process the transaction request. The service provider system, in turn, sends this information to a tax computation module 370. This module calculates the sales and/or use tax amount (for each applicable city, state and/or territory) and transmits an appropriate XML-based reply to the subscriber which includes the tax due and total amount of the transaction.

Thereafter, a subscriber system 101 can send a report request to a service provider system 102 for requesting a tax summary/audit report. The report is transmitted to the subscriber system and the result displayed preferably on the subscriber's browser, e.g., Microsoft Internet Explorer Version 4.0 or higher. The financial module of the service provider system then formulates another XML-based message to instruct the remittance server to effect the transfer of funds.

The tax payment module effects electronic transfer of funds corresponding to the amount of taxes to be paid to a service provider account 103. Then, at selected intervals (e.g., weekly, bi-weekly, monthly or quarterly), the module transfers the funds in payment of taxes owed to the government authority. It is preferred that each tax authority be given audit capability and report generation capability through direct access to the subscriber reporting module. Optionally, the subscriber may request reporting of information to determine the amount of taxes paid for the current fiscal year or other selected time period.

Alternatively or concurrently, a return-generating module 380 automatically, at selected intervals (again, e.g., weekly, bi-weekly, monthly or quarterly), generates and electronically files appropriate tax return information with selected government authorities.

Although the present invention has been shown and described in connection with various functional modules operating on a server of service provider 102, it is understood that one or more such modules may be provided on subscriber system 101, alternatively or concurrently therewith, within the spirit and scope of the present invention.

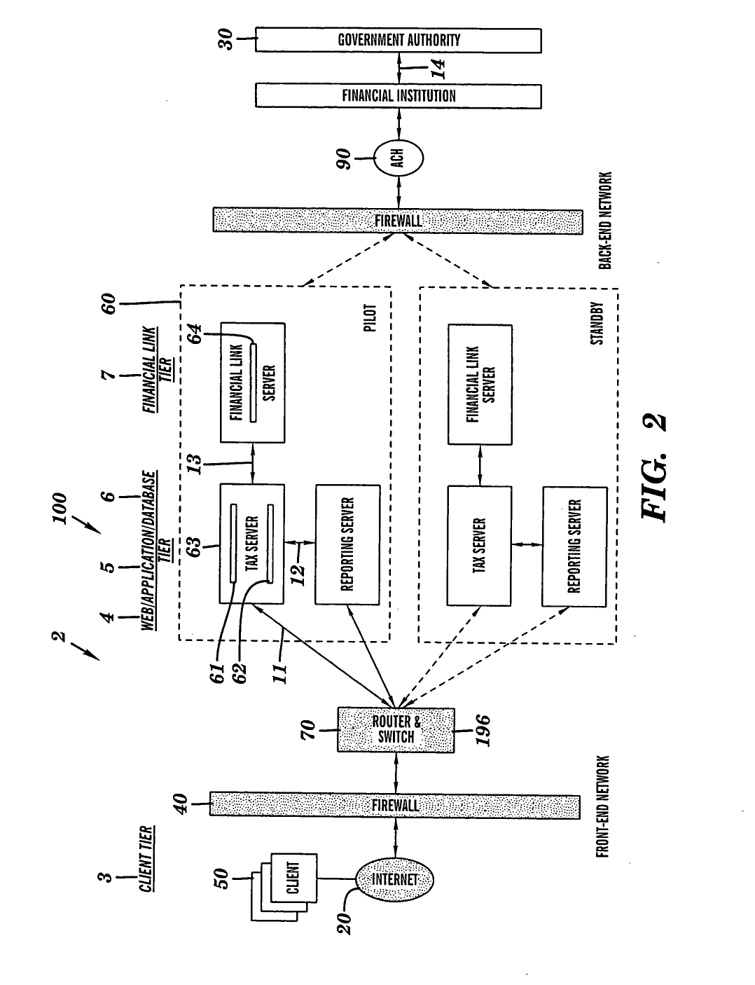

Alternatively or concurrently, and as illustrated in FIGS. 1 and 2, the system is provided with a plurality of primary servers 80, including a primary network server 81, a primary tax computation server 82, a primary report generation server 83 and a primary tax remittance server 84. The network server receives a tax computation transaction request from the subscriber server, transmits the request to the primary tax computation server, and returns data processed there to the subscriber server. A plurality of secondary servers 85 that are redundant to the first are also provided. They include a secondary network server 86, a secondary tax computation server 87, a secondary report generation server 88 and a secondary tax remittance server 89. The network server receives a tax computation transaction request from the subscriber server, transmits the request to the secondary tax computation server, and returns data processed by the tax computation server to the subscriber server.

In order to change utilization of at least one of primary servers 80 to a corresponding secondary server, load balancing and scalability system 70 conducts load directing, routing and switching functions necessary to achieve optimum management of system resources. Exemplary functions performed, where use of an alternative service is needed, include retrieval of a duplicate data set from the corresponding secondary server, optimum balance of the data load between servers, detection and activation of the secondary server as a standby for handing increased volume of data, and switching the data load from at least one of the primary servers to the secondary server upon server failure.

Preferably, at least one of secondary servers 85 has redundant programming for each function which may be performed by one or more primary servers. This includes applications such as financial data computation and report remittance over the interactive communications network. It also comprises infrastructure services such as monitoring the availability of servers of subscriber servers, for transmitting a message to a system administrator when a selected condition has been met, monitoring operating system usage, the availability of internal support processes, and for periodically performing backup of system data for auditing and database recovery. Similarly, functions for a system administrator's remote access, login/logout tracking, object creation, deletion, editing and rule base, controlling user access to at least one of the system services are duplicated on a secondary server. The same is true for other the software applications for managing system resources.

Another feature of the present invention, as set forth in FIGS. 5 and 8, is an automatic (real-time or periodic) tax calculation, reporting and payment scheme for state and federal government's treasuries on each taxable transaction of the subscriber. This arrangement virtually eliminates the need for the subscriber to manually file an annual tax return. A system of this general description is provided, for example, in a co-pending U.S. patent application, entitled AN INTELLIGENT APPARATUS, SYSTEM AND METHOD FOR FINANCIAL DATA COMPUTATION, REPORT REMITTANCE AND FUNDS TRANSFER OVER AN INTERACTIVE COMMUNICATIONS NETWORK, HP Docket No. 100111405, filed on the same date herewith by Hong M. Dang, Kooi K. Yap, Hwei-Hwa A. Lin and Martin Trostel, the disclosure of which is hereby incorporated herein in its entirety.

Turning now to a further aspect of the present invention, there is provided a method 400 for automatically computing sales tax on a selected transaction, reporting the taxes owed, and transmitting funds corresponding to the taxes owed to a selected government authority over an interactive communications network. Initially, a sales transaction request 410 is sent from a network browser of a subscriber server, over the network, to firewall device 40. Approval 420 for passage of the request through the device is obtained, and the request is sent 430 to a primary network server. Next, the request is sent 440 from the primary network server to a primary tax computation server. There, the taxes owed are determined 450 and sent 460 to a reporting server. Data processed by the tax computation server are then reported 470 to the subscriber server and/or the government authority, e.g., state government treasury. Finally, funds corresponding to the taxes computed are remitted 480 to a server of a selected financial institution for transmission to the government authority.

Alternatively or concurrently, another method 401 is provided for automatically computing sales and/or use tax on a selected transaction, reporting the taxes owed, and transmitting funds corresponding to the taxes owed to the government authority over the network. First, sales transaction request is sent 411 from a network browser of a subscriber server, over an interactive communications network, to the firewall device where approval for passage of the request through the device is obtained. Upon approval, the request is sent 431 to a primary network server.

Next, the request is transmitted 441 from the primary network server to a primary tax computation server. Upon any failure of the primary network server to provide a function desired or to provide access to data desired, a load balancing and scalability system redirects 442 the data transfer from the primary network server to a corresponding secondary network server. The secondary server has programming and data storage that is redundant to that of the primary network server, namely, for duplicating any function performed by or data stored on the server.

Thereafter, the taxes owed are computed 451 at the computation server. Again, upon any failure of the primary tax computation server to provide a function desired or to provide access to data desired, a load balancing and scalability system redirects 452 the data from the primary tax computation server to a corresponding secondary tax computation server. The secondary tax computation server also has programming and data storage that is redundant to that of the primary tax computation server for duplicating any function performed by or data stored on the server.

Next, the taxes computed are transmitted 461 to a primary reporting server, whereupon failure of the primary reporting server to provide a function desired or to provide access to data desired, a load balancing and scalability system redirects 462 the data from the primary reporting server to a corresponding secondary reporting server. The secondary reporting server's programming and data storage are similarly redundant to that of the primary reporting server to enable duplication of any function performed by, or data stored on, that server.

The data processed by the tax computation server is then reported 471 to the subscriber server. The taxes computed are transmitted 472 from the primary reporting server to the primary remittance server. Upon any failure of the primary remittance server to provide a function desired or to provide access to data desired, a load balancing and scalability system redirects 473 the data from the primary remittance server to a corresponding secondary remittance server. As before, the secondary remittance server is essentially redundant to that of the primary remittance server for duplicating any function performed by or data stored on the server. Funds 14 corresponding to the taxes computed are then remitted 481 to a server of a selected financial institution for transmission to a selected government authority.

In another embodiment, the above-described method is performed by machine code, in modular form, that is resident on a server of the service provider, hence, a service provider module version. Similarly, one or more such modules may be resident on the subscriber or subscriber system, i.e., a subscriber module version. Preferably, the subscriber, in addition to the subscriber module, has a computer system, e.g., HP 9000 Server or HP Netserver such as the O.C. Tanner Virtual Store at www.octanner.com, and/or a computerized cash register bank or network system, e.g., an in-store processor including an HP 9000 Server linked via intranet with a plurality of conventional NCR computer cash registers, Verfone or the like, suitable for effective transmission of each transaction with the service provider module.

Sales tax computation is desirably performed by conventional software, e.g., Taxware, a product of Taxware International, Inc. Alternatively or concurrently, the solution is provided by an enhanced software system for computation of sales and/or use tax for payments and accruals, e.g., T-Square. A system of this general description is described, for example, in a co-pending U.S. patent application, entitled INTELLIGENT APPARATUS, SYSTEM AND METHOD FOR FINANCIAL DATA COMPUTATION AND ANALYSIS, HP Docket No. 100110474, filed on the same date herewith by Robert J. Gallagher, Theresa O. Watson, Natalie D. Milner-Upshaw, Penny L. Arviso, Paul J. Kunzler and Barry Schneiderman, the disclosure of which is hereby incorporated by reference herein in its entirety.

In one embodiment, the service provider has a plurality of modules operating preferably over interactive communications network 30. Alternatively or concurrently, the system operates over telephone lines through a conventional mail order system, or over the counter transactions. Each time a transaction is undertaken by or with the subscriber, an electronic system at the subscriber sends a transaction message or request to the service provider, e.g., by sending an e-mail message, making a dial-up connection or the like. According to one aspect of the present invention, a transaction message is an XML-based message which contains data describing the type of goods (e.g., food), the value of the item, the subscriber location, the subscriber taxpayer number (or account number), time and date information as well as the shipping location. In response, the service provider's system delivers this information to a sales tax computation module. For instance, this module determines the correct sales tax for the transaction performed (across several states), the tax rate and formats, then sends an XML-based reply to the subscriber. The subscriber's system displays to its customer the total amount due and tax details, typically through a web browser. The customer may then decide whether or not to consummate the transaction. If the consumer accepts, a new XML-based message is sent by the subscriber system to the service provider system which stores the record of the transaction in a database.

At regular intervals (e.g., daily, weekly, monthly or quarterly), according to one aspect of the present invention, the sales tax computation module sends XML-based message requests or like instructions to the system of the present invention. These instructions ask that system to perform electronic funds transfer of appropriate funds to a service provider account and to pay the appropriate state and/or federal tax authorities. Each taxation authority is preferably given audit capability and report generation capability through direct tax authority access to the subscriber-reporting module. Also, the subscriber may request reporting of the transaction to determine the amount of the taxes paid for the current fiscal period. Optionally, a return-generating module may periodically (e.g., quarterly, semi-annually or annually) automatically generate and electronically file appropriate tax return information with the appropriate tax authorities.

It is preferred that the tax reporting and remittance functions be performed by an enhanced transaction tax system for reporting financial related data and remitting funds relating to the same. A system of this general description is described, for example, in a co-pending U.S. patent application, entitled APPARATUS, SYSTEM AND METHOD FOR REPORTING FINANCIAL DATA AND REMITTING FUNDS OVER AN INTERACTIVE COMMUNICATIONS NETWORK, HP Docket No. 100111410, filed on the same date herewith by Hong M. Dang, Hwei-Hwa. A. Lin, Martin Trostel and Kooi K. Yap, the disclosure of which is hereby incorporated by reference herein in its entirety.

Although the present invention has been shown and described in connection with a land-line, Web-based network, it will be understood by those skilled in the art that other methods could be utilized, giving consideration to the purpose for which the present invention is intended. For instance, a wireless communications network or a combination land-based and wireless network could be used, within the spirit and scope of the present invention.

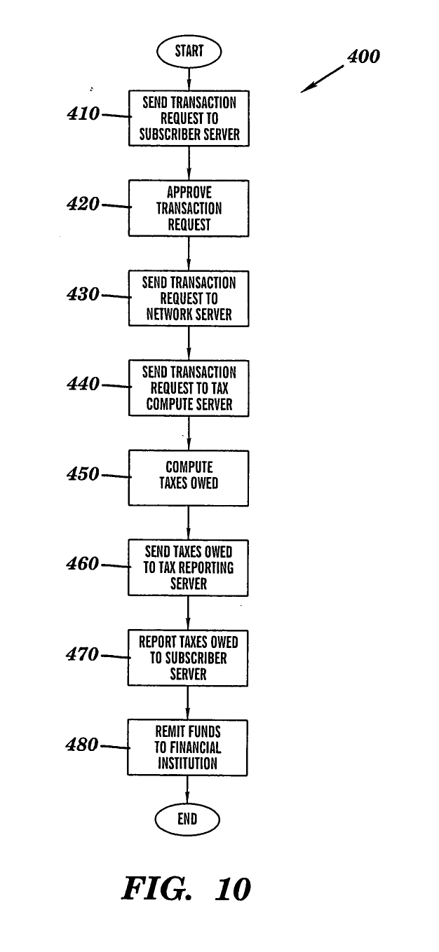

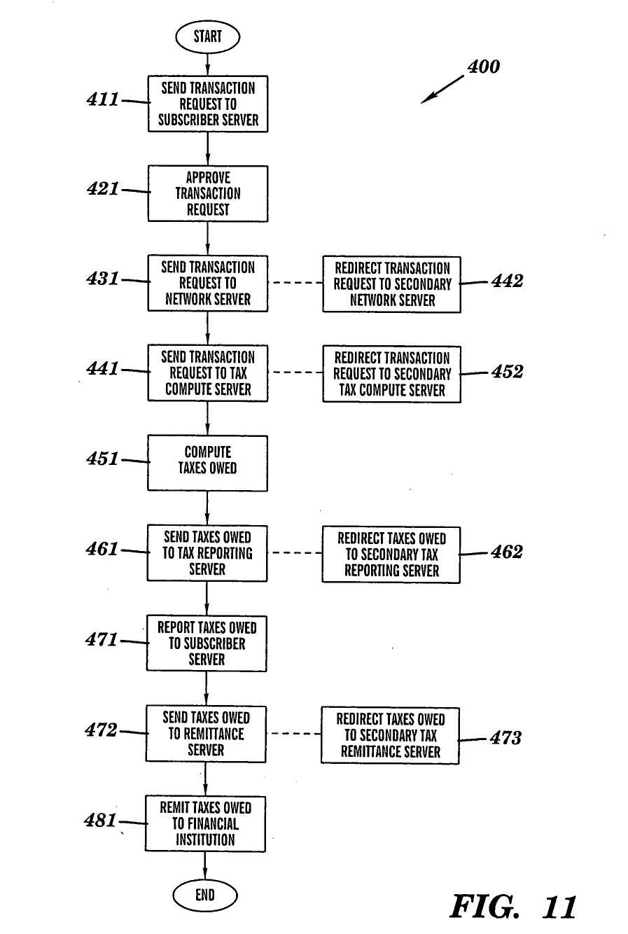

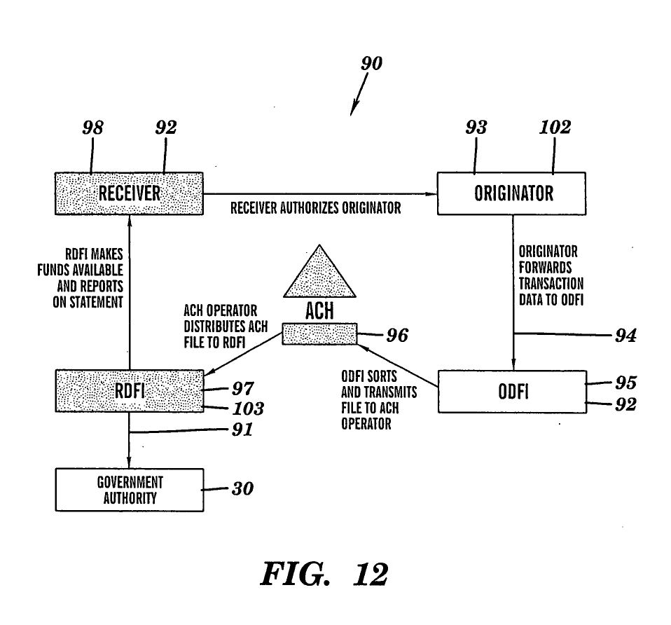

Generally speaking, according to one aspect of the present invention, as shown in FIG. 10, an automated clearinghouse network (or ACH) or access thereto is provided for facilitating the transfer of funds to government authorities. In one embodiment, an ACH is a nationwide, batch-oriented electronic funds transfer system that provides for interbank clearing of electronic payments for participating depository financial institutions, e.g., Citibank. Examples include The American Clearing House Association, Federal Reserve, Electronic Payments Network and VISA. Each of these institutions, in effect, act as a central clearing facility (or ACH operator) through which member financial institutions can transmit or receive entries through the automated clearing house.

Operation of the clearing house network is illustrated, for instance, in FIG. 6. In one embodiment, an originator, such as an individual, a corporation or other entity, that desires access to the network initiates entries in the automated clearinghouse network. This is typically done by forwarding a file containing processed tax transaction data to an originating depository financial institution (or ODFI). An ODFI is a participating financial institution that originates automated clearinghouse network entries at the request of and by agreement with its customers. Typically, ODFI's are bound by provisions of the NACHA standard industry operating rules and guidelines. The ODFI sorts and transmits the data file to an automated clearinghouse network operator.

Next, the network operator distributes the data file to a receiving depository financial institution (or RDFI). An RDFI is typically any financial institution qualified to receive automated clearinghouse network entries that also agrees to abide by the NACHA standard industry operating rules and guidelines. The RDFI makes funds corresponding to the data file available and then reports them on a statement to a receiver. The receiver is preferably an individual, a corporation or other entity authorized as an originator, i.e., to initiate a credit or debit entry to a transaction account held at the RDFI.

The foregoing description is provided for purposes of illustration and not to limit the intended environment or application of the present invention. The remaining structural and functional aspects of the automated clearinghouse network are known by those skilled in the art and further description is considered unnecessary for illustration of the present invention.

The use of an automated clearing house banking network for performing electronic funds transfer (or EFT) provides many advantages over conventional methods which utilize a credit card service for sales tax payment. First, use of such a network is considerably less expensive that performing electronic finds transfers using a credit card service. For instance, with an automated clearinghouse network, it typically costs only a few cents to execute each electronic funds transfer regardless of the amount of the transaction. A credit card transaction, on the other hand, usually involves a charge of 2%-3% of the transaction amount. Since the cost of an automated clearinghouse network funds transfer is fixed, whereas the cost of a credit card transaction increases in proportion to the size of the amount transferred, the cost savings associated with the use of the automated clearinghouse network can be very large.

In addition, the automated clearinghouse network is currently the primary way in which most domestic financial institutions accomplish electronic funds transfers. Example ACH transactions include most payroll deposits, automatic mortgage payments and car payments. Moreover, the automated clearinghouse network is advantageous in being the standard network supported by all states for sales tax remittance. The defined standard file format for sales tax remittance to all states is ACH/TXP.

Turning now to a further aspect of the present invention, system hardware preferably defines three discrete operating environments, namely, two Unix-based systems and one Windows NT server. The first Unix-based system, which is dedicated to sales tax computation operations, uses a conventional, high-performance operating system such as HP-UX 11.0 or the like. A Web server, for instance, IPlanet Web Server 4.1 SP5 is used as well as an Oracle 8i database or the like equipped with Java 1.2.2.8. Desirably, in one embodiment, system applications software includes PL/SQL, Genie, TaXML, Financial Link and XMLPost.

The second Unix-based system also utilizes a conventional Unix operating system such as HP-UX 11.0 and is dedicated to sales tax remittance functions. It is also desirable that the system utilize an Application Server, e.g., an HP BlueStone TeS 7.3 or WebLogic Web Server 5.1.0, an A-Class HP9000 Server or the like, an Oracle V 8.1.6 database, and Java 1.2.2.8. In addition, it is preferred that the system applications software comprise various off-the-shelf routines such as Saxon 5.5.1, XML Convert 2., JDOM XML Parser b6, and Commpress 2000.

Third, a Windows NT server, e.g., an IIS 4.0 or the like, is preferably used to sales tax reporting function. This server has a conventional operating system such as an NT 4.x w/SP 6 & option pack. As with the Unix-based systems above, an Oracle 8i client database with Java 1.2.2.8 is desired. Preferred application software for the server is Crystal Reports 8.0.

The present invention offers numerous benefits over conventional tax preparation and reporting methods. First, it enables subscribers to electronically outsource the burden of sales and/or use tax calculation and remittance to state-certified service providers. In this manner, subscribers need not determine the tax rates applicable to each sales transaction, nor otherwise preoccupy themselves with regional tax laws. Subscribers also need not be concerned about the accuracy of the information they provide to government authorities.

A second benefit is that subscribers may now significantly reduce their internal information technology expenses since they no longer need to maintain an in-house, internally-developed sales tax calculation system. Furthermore, the invention significantly reduces the audit exposure of participating subscribers since municipalities, states and other government authorities may now have access to complete transaction records electronically maintained by the service provider and, thus, may issue audit waivers to participating subscribers.

Finally, at the kernel of the present invention is the use of free public domain, commonly off-the-shelf (COTS) technologies, open source and other industry standard software, rather than proprietary, subscriber-specific software, such that long term supportability is assured. Examples include, but are not limited to, XML, XML/DTD, ACH/TXP, Java, JSP and J2EE, e.g., Java 1.2, HTTPS Post, SOAP, Secure Shell (SSH), SSLv3, Sudo and Apache web server software, e.g., HP-UX 11.0, and oracle database software, e.g., Oracle V 8.1.6. This reduces considerably their system development and deployment costs.

In addition, subscribers no longer must purchase tax software for each business application in their portfolio, no longer require dedicated information technology resources to administer tax systems, and no longer must build custom components to integrate tax software with their specialized business applications.

Instead, a Web service (or e-service) is provided for automatically, securely and efficiently remitting sales and/or use tax data for the subscriber. The service is readily accessible, i.e., publically over the Internet, requires only a conventional Internet browser, e.g., Microsoft Internet Explorer Version 4.0 or higher, yet maximum system and data security is provided. Unlike prior systems, no specialized communications equipment, dedicated phone line, or other independent setup is required. This virtually eliminates startup costs and other large expenses usually associated with new communications systems.

The present invention's use of industry standard tools for implementing security is another helpful aspect. In particular, it is preferred that data encryption be provided by SSLv3. Authentication desirably is provided by digital certificate, public/private key authentication of SSH. Additionally, non-repudiation and data integrity security are provided by digital signature. Finally, audit security is facilitated by logging, as will be understood by those skilled in the art.

Accordingly, relatively strong protection from fraud is also provided. First, the present invention requires off-line registration of each subscriber. In particular, each subscriber must supply a federal tax I.D. number and state tax I.D. numbers which are securely stored in the database. The automated clearinghouse network TXP file for sales tax remittance contains the subscriber's state tax I.D. number. In this manner, not only is the amount of sales tax remitted to the state correct, but also attributed to the correct subscriber. Second, the automatic debit to the automated clearinghouse network is always from the subscriber to the holding account. Third, the automated clearinghouse network credit is, in turn, always from the holding account to the states only. Fourth, the present invention utilizes a closed-loop system in which funds may only be transferred from a known and pre-registered bank account to another known and pre-registered bank account. Finally, at least one selected, authorized person must approve each fund transfer to the automated clearinghouse network.

Still another advantage of the present invention is its support of both conventional online and batch mode software. The tax calculation system sends an XML message request to the system of the present invention, which, in turn, replies with an XML message response. This on-line capability facilitates an immediate system response to any request, whether an error message, a rejection, or accepted transaction identifier. Although the above-described automated clearinghouse network was developed in the 1970's for batch processing only and, more particularly, to reliably process very large volume payments at a relatively low cost, the present invention transforms any on-line XML transaction request into an automated clearinghouse network TXP batch file. In this manner, it essentially transforms that system from a batch only operation into one that can repeatedly handle individual on-line transactions.

Overall, the present invention advantageously provides a continuously available, highly secure, automated system and method, at the user level, systems level and network level, for facilitating computation of taxes owed on sales transactions and remission of the same over an interactive communications network. In this manner, it also insures that tax computations, which were previously done manually, are done quickly, effectively, correctly and relatively paperlessly. Tax reporting is now accomplished in a timely manner, without tardiness or loss in the mail. The present invention insures any additional taxes due are paid, and eliminates penalties for late or incorrect tax payments. Moreover, collection of taxes by government treasuries is insured as taxes are paid directly via electronic funds transfer to the treasuries, seamlessly, economically and error free across multiple tax jurisdictions. Even sales tax on transactions conducted over the Internet, that were previously uncollectible by states, may be paid without additional effort by the subscriber or customer. In effect, the need for filing a tax return is eliminated.

Furthermore, the system infrastructure also enables subscribers to electronically outsource the burden of sales tax calculation and sales tax remittance to state-certified service providers. Concomitantly, this significantly reduces the internal information technology expenses of subscribers by eliminating the need to maintain an in-house internally-developed sales tax system. Audit exposure of participating subscribers is also eliminated by giving government authorities access to complete transaction records electronically maintained by the service.

Further, by making use of off-the-shelf (COTS) technologies, Internet software industry standards, such as XML, Java, HTTPS, SOAP, Secure Shell (SSH) and other opens source industry standard software, not only are development and deployment costs are substantially reduced, but also long-term supportability is insured.

Various modifications and alterations to the present invention may be appreciated based on a review of this disclosure. These changes and additions are intended to be within the scope and spirit of this invention as defined by the following claims.

1. (canceled)

2. (canceled)

3. (canceled)

4. (canceled)

5. (canceled)

6. A method for automatically computing sales tax on a selected transaction, reporting the taxes owed, and transmitting funds corresponding to the taxes owed over an interactive communications network, the method comprising the steps of:
(i) sending a transaction request from a network browser of a subscriber server, over the network, to a firewall of a program controlled system for providing financial data computation, report remittance and funds transfer services;
(ii) obtaining approval for passage of the request through the device and sending the approved request to a primary network server;
(iii) transmitting the request from the primary network server to a primary tax computation server;
(iv) computing the taxes owed on the computation server;
(v) storing the taxes computed in a database server under a selected subscriber account;
(vi) sending a response with the amount of taxes computed to the subscriber server; (vii)
transmitting the taxes computed to a reporting server upon receiving a report transaction request from the subscriber server and/or government authority;
(viii) reporting the data processed by the tax computation server to the subscriber server and/or government authority; and
(ix) remitting funds corresponding to the taxes computed to a server of a selected financial institution for transmission to a selected government authority.

7. A method for automatically computing sales tax on a selected transaction, reporting the taxes owed, and transmitting funds corresponding to the taxes owed over an interactive communications network, the method comprising the steps of:
(i) sending a transaction request from a network browser of a subscriber server, over the network, to a firewall of a program controlled system for providing financial data computation, report remittance and funds transfer services;
(ii) obtaining approval for passage of the request through the device and sending the approved request to a primary network server;
(iii) transmitting the request from the primary network server to a primary tax computation server, whereupon failure of the primary network server, a load balancing and scalability system redirects the data transfer from the primary network server to a corresponding secondary network server, the secondary server having programming that is redundant to that of the primary network server;
(iv) computing the taxes owed on the computation server, whereupon failure of the primary tax computation server, a load balancing and scalability system redirects the data transfer from the primary tax computation server to a corresponding secondary tax computation server, the secondary tax computation server having programming that is redundant to that of the primary tax computation server;
(v) storing the taxes computed in a database server under a selected subscriber account;
(vi) sending a response with amount of taxes computed to the subscriber server, whereupon failure of the primary tax computation server, a load balancing and scalability system redirects the data transfer from the primary tax computation server to the corresponding secondary tax computation server;
(vii) transmitting the taxes computed to a primary reporting server, whereupon failure of the primary reporting server, a load balancing and scalability system redirects the data transfer from the primary reporting server to a corresponding secondary reporting server, the secondary reporting server having programming that is redundant to that of the primary reporting server;
(viii) reporting the data processed by the tax computation server to the subscriber server and/or the government authority; and
(vii) transmitting the taxes computed from the primary reporting server to the primary remittance server, whereupon failure of the primary remittance server, a load balancing and scalability system redirects the data transfer from the primary remittance server to a corresponding secondary remittance server, the secondary remittance server having programming that is redundant to that of the primary remittance server; and
(viii) remitting funds corresponding to the taxes computed to a server of a selected financial institution for transmission to a selected government authority.

8. (canceled)

9. (canceled)
